(19) United States
(12) Patent Application Publication
(10) Pub. No.: US 2015/0263637 A1
(43) Pub. Date: Sep. 17, 2015

(54) CONVERTER SYSTEM AND METHOD FOR CONVERTING ALTERNATING CURRENT

(71) Applicant: Siemens Aktiengesellschaft, Munich (DE)

(72) Inventor: Lijian Wu, Ikast (DK)

(73) Assignee: SIEMENS AKTIENGESELLSCHAFT, Munich (DE)

(21) Appl. No.: 14/641,338

(22) Filed: Mar. 7, 2015

(30) Foreign Application Priority Data
Mar. 14, 2014 (DE) 102014204802.8

(51) Int. Cl. H02M 5/458; F03D 9/00

(52) U.S. Cl. CPC H02M 5/458; F03D 9/003

(57) ABSTRACT

A converter system for converting alternating current of variable frequency into alternating current of constant frequency is provided, having: a first converter electrically connected to a first set of turns of a generator; and at least a second converter electrically connected to a second set of turns of the generator, wherein the first converter in a first operating mode determines a first estimated rotor position of the generator, and performs driving operations of first power transistors, contained in the first converter, for converting the alternating current based on the first estimated rotor position, wherein the second converter in a first operating mode receives the first estimated rotor position of the generator from the first converter, and performs driving operations of second power transistors, contained in the second converter, for converting the alternating current based on the first estimated rotor position.

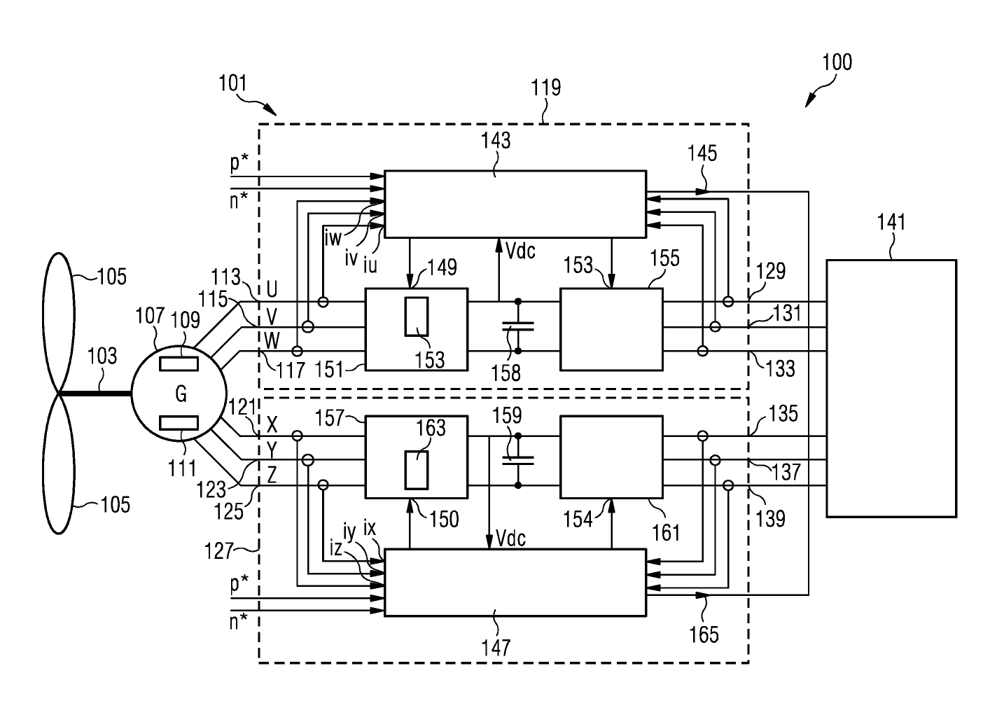

### CROSS REFERENCE TO RELATED APPLICATIONS

This application claims the benefit of German Application No. DE 102014204802.8 filed Mar. 14, 2014, incorporated by reference herein in its entirety.

### FIELD OF THE INVENTION

The present invention relates to a converter system and to a method for converting alternating current of variable frequency into alternating current of constant frequency, which system can be used for an electrical generator having a plurality of sets of electrically insulated turns.

### BACKGROUND

In a wind turbine, a generator can be driven by a rotating shaft to which a plurality of paddles or rotor blades are fitted. The generator can output alternating current of varying frequency depending on the rotation frequency of the rotor which drives the generator. In order to be able to feed electrical energy to a supply system which provides consumers with the electrical energy at a prespecified alternating frequency, such as 50 Hz or 60 Hz for example, the energy or power of variable frequency, which is delivered by the generator, has to be converted into energy or power or current or voltage of fixed frequency.

For this purpose, the prior art uses a converter which has a generator-end part, a direct current part and a supply system-end part. The energy flow of variable frequency is converted into a direct current in the generator-end part of the converter, and additionally smoothed in the direct current part of the converter. The direct current is converted into an alternating current of fixed (prespecified) frequency in the supply system-side part. In this case, the generator-side part and also the supply system-side part of the converter can each have a series of power transistors which are driven by pulse-width modulation signals at their respective gates in order to achieve the conversion into direct current or the conversion into alternating current of fixed frequency.

The generator can have, in particular, two or more sets of electrically insulated turns which are each wound around teeth of a stator. Each set of turns or windings (wherein each set can comprise, for example, three electrical phases), can be supplied to an associated converter in order to achieve the conversion.

However, it has been observed that a system comprising a generator with a plurality of sets of electrically insulated turns and a plurality of converters for converting the energy flow of each set of the electrically insulated turns generates a relatively high level of noise or a high noise level and vibrations, and this can lead to mechanical and/or electrical loading of components of the system and furthermore is found to be disturbing.

In conventional systems, a method of injection of harmonic current has been carried out in order to damp the fluctuations in torque. In this way, the vibration and the noise can be damped at a certain frequency. However, control of this kind requires additional effort and care in order to precisely set the parameters. However, the parameters cannot be used to reduce the vibration and noise problem in every scenario or under all conditions.

There is therefore a need for a converter system and a method for converting alternating current, which system exhibits a lower level of vibration and noise than corresponding prior art systems.

### SUMMARY OF THE INVENTION

The need is met by the subjects of the independent claims. The dependent claims specify particular embodiments.

According to one embodiment of the present invention, a converter system for converting alternating current of variable frequency into alternating current of constant frequency is provided, wherein the converter system has: a first converter which can be electrically connected to a first set of turns of a generator, and at least a second converter (or three, four, five or more) which can be electrically connected to a second set of turns of the generator, wherein the first converter is designed, in a first operating mode, to determine a first estimated rotor position of the generator, and to perform driving operations of first power transistors, which are contained in the first converter, for converting the alternating current based on the first estimated rotor position, wherein the second converter is designed, in a first operating mode, to receive the first estimated rotor position of the generator from the first converter, and to perform driving operations of second power transistors, which are contained in the second converter, for converting the alternating current based on the first estimated rotor position.

The converter system can be contained, for example, within a wind turbine in which an electrical generator is coupled to a rotor to which a plurality of rotor blades or paddles are fitted, and generates an alternating current or energy flow of variable frequency (depending on the rotation frequency of the rotor). The constant frequency may be, for example, 50 Hz or 60 Hz. The first converter and also the second converter can each comprise a generator-end part (a direct current-generating part or rectifier) and a consumer supply system-end part (part which generates alternating current of fixed frequency), wherein both the generator-end part and also the consumer supply system-end part can each have power transistors. In particular, each part can comprise, for example, in each case two power transistors for each phase of the alternating current. According to one particular embodiment, the generator-end part of the first converter or of the second converter can comprise, for example, six power transistors in order to support three phases and also the consumer supply system-end part of the first converter or of the second converter can in each case comprise six power transistors in order to make available a three-phase energy flow to the consumer supply system. A direct current part (DC link) can be arranged between the generator-end part and the consumer supply system-end part, said direct current part comprising, in particular, a capacitor or a capacitor system in order to smooth the energy flow which is (partially) rectified by the generator-end part. Each converter, that is to say the first converter and also the second converter, can in each case comprise a control system, in particular the first capacitor can comprise a first control system, and the second capacitor can comprise a second control system, in order to drive the power transistors in the respective converter to open and close, in particular by pulse-width modulation signals which are supplied to the respective gates of the power transistors.

The first set of turns of the generator is electrically insulated from the second set of turns. The first set of turns can extend either around the entire circumference of the stator of the generator or can be arranged, for example, only in a subregion (or separate subregions) of the circumference of the generator, for example over half of said circumference. The first set of turns can therefore overlap with the second set of turns over the circumference or, in other embodiments, not overlap over the circumference.

In particular, a set of measurement values which represent currents of the first set of turns can be supplied to the first converter. In particular, the first set of turns can correspond to three phases, and measurement values relating to a current in the first phase (also called U current), a measurement value relating to a current in the second phase (also called V current) and a measurement value relating to a current in the third phase (also called W current) can be supplied to the first control system. The first control system can determine the first estimated rotor position of the generator based on the U current, the V current and the W current.

In this case, the first estimated rotor position is an estimation of an angular position of the rotor (which rotates within the generator), it being necessary to know said angular position in order to drive the first power transistors in such a way that a desired rectification is achieved. Various methods, as are known in the prior art, can be used in order to determine the estimated rotor position of the generator. Details of various estimation methods can be found, for example, in U.S. Pat. No. 6,163,127.

In the first operating mode, the first converter therefore acts in a sensor-free control mode, that is to say, in a mode without using an additional sensor, to determine the actual rotor position by a measurement.

In addition to the measurement values relating to the currents in the first set of turns, reference values for active power, reactive power, voltage, current, etc. can further be supplied to the first control system or to the first converter, it being possible for said reference values to be used, in particular, to determine driving signals for power transistors of the consumer supply system-end part in order to achieve a desired active power, reactive power, voltage, current at an output connection or polyphase output port of the first converter.

In the first operating mode, the first converter outputs a signal, which represents the first estimated rotor position, to the second converter. The second converter receives the first estimated rotor position (for example represented by an electrical, optical signal) from the first converter and is operated in a mode, which is conventionally also called an operating mode, in which a measurement signal relating to a current position of the rotor is received (sensored control). An operating mode of this kind is supported in conventional converters and therefore the converter system can be assembled from conventionally available converters by, for example, the first estimated rotor position being supplied from the first converter to an input of the second converter which is provided in a conventional system for receiving a measurement signal for the current rotor position.

In its first operating mode, the second converter does not itself determine an estimated rotor position, but rather instead uses the first estimated rotor position which is determined by the first converter and controls the second power transistors, which are contained in the second converter, based on this first estimated rotor position. In particular, the second power transistors, which are driven based on the first estimated rotor position, can be arranged partially or exclusively in the generator-end part of the second converter. The first power transistors of the first converter can also be arranged in the generator-end part of the first converter.

The generator can have, for example, two sets of three-phase windings. The two sets are electrically insulated from one another. The advantage of a system of this kind is that, when a set of windings or one of the first capacitors or of the second capacitors has technical problems, the other system can nevertheless further generate electrical energy. However, the two sets of turns can be magnetically coupled. By way of example, the currents in one set of turns can significantly influence the voltage in the other set of turns.

According to this embodiment of the present invention, the first converter and the second converter are therefore operated by the same (estimated) rotor position as input. In particular, the first converter can have an equal or identical structure to the second converter. The first converter and the second converter are therefore not operated independently of one another. In conventional systems, it may be the case that the respectively estimated rotor positions are slightly different in independently operated converters since the plurality of sets of windings are magnetically coupled and therefore the currents in one set of turns influence the voltages and currents of another set of turns. Therefore, an estimation of the rotor position, which is based on current measurements, may be different for the various converters, according to conventional systems. In conventional systems, this error or this deviation between the estimated rotor positions, which are determined by different converters, can lead to an error in the Id and Iq thereof, and this, in turn, can lead to an error in the rotor position estimation. Therefore, a relatively high level of vibration and development of noise would be observed in conventional systems since even a slight misalignment in the estimated rotor position of two converters can generate significant fluctuations in torque (torque ripple). It has also been observed that conventional two-converter systems have a considerably greater level of vibration and noise than a single-converter system with only one set of turns.

According to one embodiment of the present invention, the generator supports two (or three, four, five to eight or more) sets of three-phase turns or windings. The two sets of turns are connected to the first and to the second converter. In the first operating mode, the first converter can act as the main system and carry out “sensorless control”, while the second converter carries out control which is conventionally called “sensored control”. To this end, the first converter outputs the first estimated rotor position to the second converter. The second converter can generate the gate signals for its generator-end converter part (the rectifier) according to the first estimated rotor position signal from the first converter. Even though the second converter uses the sensored control algorithm, the overall system does not require a rotor position sensor since the first converter fulfills the function of a rotation position sensor (by estimation of the rotor position). In this way, the first converter and the second converter share the same estimated rotor position, so that the problem of a deviation between two independently estimated rotor positions is eliminated or at least reduced, and, as a result, this can also lead to a lower level of vibration and a lower level of noise.

According to one embodiment of the present invention, the converter system is configured in such a way that the second converter is designed to enter a second operating mode, wherein the second converter is designed, in the second operating mode: to determine a second estimated rotor position of the generator, and to perform driving operations of the second power transistors based on the second estimated rotor position.

Therefore, in the second operating mode, the second converter is designed, for its part, to estimate a rotor position, that is to say the second estimated rotor position. As a result, independence from the functioning of the first converter can be achieved in the event of an error, and this can allow continuous operation.

According to one embodiment of the present invention, the second converter is designed to enter the second operating mode in the event of no first estimated rotor position of the generator being received on account of an error in the first converter and/or a data transmission error.

Therefore, the second converter can also execute its conversion function when it does not receive the first estimated rotor signal, for example on account of an error.

To this end, the second converter can automatically enter the second operating mode if it does not receive a first estimated rotor position or an associated signal. The first capacitor and the second capacitor are physically the same converter. The two systems can execute both sensorless control and sensored control, that is to say can estimate both a respective rotor position or can receive the estimated rotor position from the respectively other converter. The first converter can be set up as a main system, wherein its sensorless control is activated and its sensored control is deactivated either by hardware or software. In contrast to this, the sensorless control of the second converter can be deactivated and its sensored control can be activated either by hardware or by software. The first converter can output its first estimated rotor position to the second converter, so that the second converter can generate the gate signal or the gate signals according to the first estimated rotor position. Only one type of converter is required in this way. If the first converter exhibits functional interference, the sensorless control of the second converter can be easily activated, so that the second converter becomes the main converter system and can be operated independently of the first converter.

The activation of the sensed control algorithm and the deactivation of the sensorless control algorithm of the second converter can be performed automatically. The second control system of the second converter can detect whether there is an input signal relating to a rotor position. If a rotor position signal is received or is detected, the second converter can automatically activate the sensored control process (first operating mode of the second converter) and deactivate the sensorless control process (second operating mode of the second converter).

According to one embodiment of the present invention, the first converter is designed, in a second operating mode, to receive the second estimated rotor position of the generator from the second converter, and to perform driving operations of the first power transistors based on the second estimated rotor position. Therefore, the first converter and the second converter can exchange roles in comparison to the respective first operating mode. Therefore, continued operation and continued energy generation can be improved.

According to one embodiment of the present invention, the converter system is configured in such a way that the second converter is designed to enter a third operating mode, wherein the second converter is designed, in the third operating mode, to determine the second estimated rotor position of the generator, to receive the first estimated rotor position of the generator from the first converter, and to perform driving operations of the second power transistors based on the first estimated rotor position and the second estimated rotor positions.

Therefore, the second converter can use both the first estimated rotor position and also the (self-determined) second estimated rotor position of the generator to determine driving signals, in particular gate signals, for driving the second power transistors. As a result, the conversion can be further improved. In particular, each estimated rotor position, that is to say the first estimated rotor position and the second estimated rotor position, can exhibit errors which can be reduced by taking into account the two estimated rotor positions.

According to one embodiment of the present invention, the converter system is configured in such a way that the first converter is designed to enter a third operating mode, wherein the first converter is designed, in the third operating mode, to perform driving operations of the first power transistors based on the first estimated rotor position and the second estimated rotor positions.

Therefore, the first converter can also use the two estimated rotor positions to determine or calculate gate signals for driving the first power capacitors, and this can further improve the operation of the converter system, in particular if the respectively estimated rotor positions exhibit errors.

According to one embodiment of the present invention, the first converter and/or the second converter are/is designed, in the respectively third operating mode, to compare the second estimated rotor position of the generator with the first estimated rotor position of the generator in order to determine a difference between the estimated rotor positions, wherein the second converter is designed, in the third operating mode, to perform driving operations of the second power transistors based on the second estimated rotor position if the difference is greater than a threshold value.

A comparison of the first estimated rotor position with the second estimated rotor position can identify an error or a plurality of errors in the respective estimations, in particular if the difference between the estimated rotor positions is relatively large, that is to say greater than the threshold value. If the difference is greater than the threshold value, this can indicate that the first estimated rotor position exhibits large deviations from an actual rotor position, and therefore the second converter cannot trust the first estimated rotor position. Therefore, the second converter uses its own second estimated rotor position in order to perform driving operations of the second power transistors. The operation of the converter system can be further improved as a result.

According to one embodiment of the present invention, the first converter is designed, in the third operating mode, to perform driving operations of the first power transistors based on the first estimated rotor position if the difference is greater than the threshold value.

Therefore, in this case, incorrect estimation of the rotor position by the second converter can be detected, and in response to this the first converter instead uses its own estimated rotor position, that is to say the first estimated rotor position, for driving the first power transistors.

The deactivation of the sensorless algorithm (second operating mode of the second converter) can have two options: (1) estimation of the rotor position is stopped or (2) the second converter continues to estimate the rotor position, but the estimated rotor position, that is to say the second estimated rotor position, is not used in order to generate the driving signals for the second power transistors. In this second option, the second converter can continuously compare the two estimated rotor positions, that is to say the first estimated rotor position and the second estimated rotor position, in order to calculate the difference. If the difference is within a preset range, the second converter can use the first estimated rotor position (which is retained by the first converter) in order to generate the driving signals for the second power transistors. If, however, the difference is greater than the threshold value, the second converter can determine that the first estimated rotor position cannot be trusted and instead use the second estimated rotor position in order to generate the driving signals for the second power transistors.

According to one embodiment of the present invention, the first converter is designed, in the third operating mode, to perform driving operations of the first power transistors based on an intermediate value between the first estimated rotor position and the second estimated rotor position, wherein the second converter is designed, in the third operating mode, in particular to perform driving operations of the second power transistors based on the intermediate value.

If both the first estimated rotor position and the second estimated rotor position exhibit deviations from the actual rotor position, the intermediate value can have a smaller deviation from the actual rotor position. Therefore, a use of the intermediate value in order to generate respective driving signals for the first power transistors and/or the second power transistors can lead to an improvement of the converter system.

According to one embodiment of the present invention, the first converter is designed to determine the first estimated rotor position of the generator based on electric currents in the first set of turns, wherein the second converter is designed to determine the second estimated rotor position of the generator based on electric currents in the second set of turns.

The estimations on the basis of the electric currents (in particular three currents and accordingly three phases) can be performed by various methods, as are known from the prior art (for example U.S. Pat. No. 6,163,127). Therefore, conventional methods for implementing the converter system can be used.

According to one embodiment of the present invention, the first set of turns and/or the second set of turns each have/has at least three groups of turns which are wound around teeth of the generator and which are electrically insulated from one another. The first set of turns and the second set of turns can be wound around the teeth of a stator of the generator. Various winding methods can be used. The first set of turns can be guided out of the generator by three electrical conductors which are connected or can be connected to three electrical input connections of the generator-end part of the first converter.

According to one embodiment of the present invention, the first set of turns is wound so as to overlap with the second set of turns in the circumferential direction of the generator.

Therefore, a variety of winding configurations can be supported.

According to one embodiment of the present invention, the converter system is configured in such a way that driving operations of the first and/or second power transistors are performed by supplying gate driver signals, in particular pulse-width modulation signals, to gates of the first and/or second power transistors. The driving operations or the generation of the gate driver signals can be carried out in each case by the first control system (for the first converter) and the second control system (for the second converter).

According to one embodiment of the present invention, a wind turbine is provided, said wind turbine having a rotor comprising rotor blades, having a generator which can be driven by the rotor, and having a converter system according to one of the preceding embodiments.

It should be noted that features which are described, mentioned, explained or provided individually or in any combination in connection with a converter system according to one embodiment of the present invention can also be used or provided individually or in any combination for a method for converting alternating current of variable frequency into alternating current of constant frequency according to an embodiment of the present invention.

According to one embodiment of the present invention, a method for converting alternating current of variable frequency into alternating current of constant frequency is provided, wherein the method comprises: determining a first estimated rotor position of the generator by a first converter which is electrically connected to a first set of turns of a generator, performing driving operations of first power transistors, which are contained in the first converter, for converting the alternating current based on the first estimated rotor position, a second converter, which is electrically connected to a second set of turns of a generator, receiving the first estimated rotor position of the generator from the first converter, and performing driving operations of second power transistors, which are contained in the second converter, for converting the alternating current based on the first estimated rotor position.

Further advantages and features of the present invention can be found in the following exemplary description of currently preferred embodiments. The individual figures in the drawing of this application are to be considered merely as schematic and not true-to-scale.

### BRIEF DESCRIPTION OF THE DRAWINGS

The FIGURE schematically shows a wind turbine which comprises a converter system according to one embodiment of the present invention.

### DETAILED DESCRIPTION

The FIGURE schematically illustrates a wind turbine 100 which comprises a converter system 101 according to one embodiment of the present invention. Said wind turbine is a directly driven wind power plant without shaft. The rotor of the generator is driven directly by the rotor 103 (blades 105 and hub) which is connected by a main bearing. The rotor of the generator is equipped with permanent magnets and surrounds the stator of the generator.

The turbine 100 comprises a rotor 103 to which a plurality of paddles or rotor blades 105 are fitted. The rotor 103 rotates within a generator 107, which has a stator, not illustrated, around which a first set 109 of turns and a second set 111 of turns are wound, said turns being identified only schematically in the FIGURE. The first set 109 of turns and the second set 111 of turns can be arranged so as to overlap (in a circumferential direction) or to not overlap within the stator of the generator 107.

Electrical conductors 113, 115 and 117, which supply three electrical phases U, V and W to a first converter 119, are routed out of the generator 107 from the first set 109 of turns. Electrical conductors 121, 123 and 125, which correspond to the three phases X, Y and Z, are supplied to a second converter 127 from the second set 111 of electrical turns within the generator 107.

The converter system 101 comprises the first converter 119 and the second converter 127 which converters convert energy flows, which are generated in the first set 109 of turns or are generated in the second set 111 of turns, into an energy flow which has the phases 129, 131 and, respectively, 133 and the three phases 135, 137 and, respectively, 139, which are finally supplied to a consumer supply system 141, by the first converter 119 or the second converter 127.

The first converter 119 comprises a first control system 143 which receives current measurement signals iw, iv, iu which represent the magnitude of currents within the first set 109 of turns. Based on the measured currents iw, iv, iu, the first control system 143 of the first converter 119 estimates a first estimated rotor position 145 which is output by the first converter 119 and is supplied to a second control system 147 of the second converter 127. In particular, the first converter 119 outputs, in a first operating mode, the first estimated rotor position 145 to the second converter 127 which receives the first estimated rotor position 145. In the first operating mode, the first control system 143 generates driving gate signals 149 based on the first estimated rotor position 145 and supplies these driving signals 149 to a generator-end part 151 of the converter 119, in particular on first power transistors 153 which are illustrated in the FIGURE. Other driving signals 153 are supplied to a consumer supply system-end part 155 (also called inverter). The output phases or measurement signals of a current or a voltage of these phases 129, 131, 133 are likewise supplied to the first control system 143 in order to use these output phases 129, 131, 133 to determine the driving signals 149 and/or 153. Furthermore, the first control system 143 receives external signals P*, n* which can represent or can be derived from, for example, active power, reactive power, voltage, current in the output phases 129, 131, 133. The first converter 119 comprises a capacitor 158 between the generator-end part 151 and the consumer supply system-end part 155.

The second converter 127 is of physically identical design and structure to the first converter 119 and also comprises a generator-end part 157 (also called rectifier), a capacitor 159 and a consumer supply system-end part 161 (also called inverter).

In the first operating mode, the first converter 119 determines the first estimated rotor position 145 and controls the first power transistors 153 based on the first estimated rotor position 145. In its first operating state, the second converter 127 receives the first estimated rotor position 145 and, for its part, controls second power transistors 163 (within the rectifier 157) based on the first estimated rotor position 145.

In a second operating mode however, the second converter 127 determines a second estimated rotor position 165 based on the three phase currents iz, iy, ix which correspond to measured currents of the phases 121, 123, 125. In this second operating mode, the second converter 127 controls the second power transistors 163 within the rectifier 157 based on the second estimated rotor position 165. The second converter 127 can enter this second operating mode (for example in an automatic manner) when it detects that a signal 145 which represents the first estimated rotor position is not received, in particular is not received having been output by the first converter 119.

In a second operating mode, the first converter 119 can be designed to receive a second estimated rotor position 165 which is output by the second converter 127, and to drive the first power transistors 153 based on the second estimated rotor position. As an alternative, the first converter 119 can, in its second operating state, as in its first operating state, drive the first power transistors 153 based on the first estimated rotor position 145.

In a third operating mode of the second converter 127, the second converter 127 determines both the second estimated rotor position 165 based on the turn currents iz, iy, ix and also the second converter 127 receives the first estimated rotor position 145 from the first converter 119. Based both on the first estimated rotor position 145 and also on the second estimated rotor position 165, the first converter 127 drives the second power transistors 163, that is to say generates corresponding gate driver signals for gates of the second power transistors 163. In a third operating mode, the first converter 119 can also be designed to determine the gate driver signals 149 based both on the first estimated rotor position 145 and also on the second estimated rotor position 165 which is received by the second converter 127.

In the third operating mode, the second converter 127 can, for example, compare the first estimated rotor position 145, which is received by the first converter, with the self-determined second estimated rotor position 165 in order to determine a difference. If the difference exceeds a threshold value, the second converter 127 can drive the gate driver signals 150 based only on the self-estimated or self-determined second estimated rotor position 165. The first converter 119 can act in a similar manner.

According to another embodiment, the first converter 119 and/or the second converter 127 can each themselves determine an estimated rotor position and receive another estimated rotor position which is determined by the respectively other converter, and drive the respective power transistors 153, 163 based, for example, on an intermediate value between the self-determined estimated rotor position and the received estimated rotor position, for example based on an average value.

Embodiments of the present invention allow two or more converter systems, such as the first converter 119 and the second converter 127 for example, to jointly use the same rotor position signal, so that driving operations of respective power transistors can take place in a consistent manner, so that the development of noise and vibration can be significantly reduced. The reliability of the system can be improved as a result. The concept according to various embodiments can be extended to generators having more than two sets of electrically independent turns. In embodiments of this kind, each set of turns can be connected to an associated converter within a generator, it being possible for said converter to exchange rotor position signals with one or more other converters, and to drive the respective power transistors based on jointly exchanged rotor position signals.

1. A converter system for converting alternating current of variable frequency into alternating current of constant frequency, wherein the converter system comprises:
a first converter which can be electrically connected to a first set of turns of a generator; and
at least a second converter which can be electrically connected to a second set of turns of the generator,
wherein the first converter is designed, in a first operating mode,
to determine a first estimated rotor position of the generator, and
to perform driving operations of first power transistors, which are contained in the first converter, for converting the alternating current based on the first estimated rotor position,
wherein the second converter is designed, in a first operating mode,
to receive the first estimated rotor position of the generator from the first converter, and
to perform driving operations of second power transistors, which are contained in the second converter, for converting the alternating current based on the first estimated rotor position.

2. The converter system as claimed in claim 1,
wherein the second converter is designed to enter a second operating mode,
wherein the second converter is designed, in the second operating mode:
to determine a second estimated rotor position of the generator, and
to perform driving operations of the second power transistors based on the second estimated rotor position.

3. The converter system as claimed in claim 2,
wherein the second converter is designed to enter the second operating mode in the event of no first estimated rotor position of the generator being received on account of an error in the first converter and/or a data transmission error.

4. The converter system as claimed in claim 2,
wherein the first converter is designed, in a second operating mode,
to receive the second estimated rotor position of the generator from the second converter, and
to perform driving operations of the first power transistors based on the second estimated rotor position.

5. The converter system as claimed in claim 1,
wherein the second converter is designed to enter a third operating mode,
wherein the second converter is designed, in the third operating mode:
to determine the second estimated rotor position of the generator,
to receive the first estimated rotor position of the generator from the first converter, and
to perform driving operations of the second power transistors based on the first estimated rotor position and the second estimated rotor positions.

6. The converter system as claimed in the preceding claim 5,
wherein the first converter is designed to enter a third operating mode,
wherein the first converter is designed, in the third operating mode:
to perform driving operations of the first power transistors based on the first estimated rotor position and the second estimated rotor positions.

7. The converter system as claimed in claim 5,
wherein the first converter and/or the second converter are/is designed, in the respectively third operating mode,
to compare the second estimated rotor position of the generator with the first estimated rotor position of the generator in order to determine a difference between the estimated rotor positions,
wherein the second converter is designed, in the third operating mode,
to perform driving operations of the second power transistors based on the second estimated rotor position if the difference is greater than a threshold value.

8. The converter system as claimed in claim 7,
wherein the first converter is designed, in the third operating mode,
to perform driving operations of the first power transistors based on the first estimated rotor position if the difference is greater than the threshold value.

9. The converter system as claimed in claim 6,
wherein the first converter is designed, in the third operating mode,
to perform driving operations of the first power transistors based on an intermediate value between the first estimated rotor position and the second estimated rotor position,
wherein the second converter is designed, in the third operating mode,
to perform driving operations of the second power transistors based on the intermediate value.

10. The converter system as claimed in claim 1,
wherein the first converter is designed to determine the first estimated rotor position of the generator based on electric currents in the first set of turns,
wherein the second converter is designed to determine the second estimated rotor position of the generator based on electric currents in the second set of turns.

11. The converter system as claimed in claim 1,
wherein the first set of turns and/or the second set of turns each have/has at least three groups of turns which are wound around teeth of the generator and which are electrically insulated from one another.

12. The converter system as claimed in claim 1;
wherein the first set of turns is wound so as to overlap with the second set of turns in the circumferential direction of the generator.

13. The converter system as claimed in claim 1,
wherein driving operations of the first and/or second power transistors are performed by supplying gate driver signals to gates of the first and/or second power transistors.

14. A wind turbine comprising:
a rotor comprising rotor blades;
a generator which can be driven by the rotor; and
a converter system as claimed in claim 1.

15. A method for converting alternating current of variable frequency into alternating current of constant frequency, wherein the method comprises:
determining a first estimated rotor position of the generator by a first converter which is electrically connected to a first set of turns of a generator;
performing driving operations of first power transistors, which are contained in the first converter, for converting the alternating current based on the first estimated rotor position;
a second converter, which is electrically connected to a second set of turns of the generator, receiving the first estimated rotor position of the generator from the first converter; and
performing driving operations of second power transistors, which are contained in the second converter, for converting the alternating current based on the first estimated rotor position.

16. The converter system as claimed in claim 1,
wherein driving operations of the first and/or second power transistors are performed by supplying gate driver signals comprising pulse-width modulation signals to gates of the first and/or second power transistors, within a rectifier part of the respective converter.
